(19) United States
(12) Patent Application Publication
(10) Pub. No.: US 2025/0297767 A1
(43) Pub. Date: Sep. 25, 2025

(54) Controlled dual-flow mechanical ventilation box comprising a partition wall that has a curved shape

(71) Applicant: ALDES AERAULIQUE, VENISSIEUX (FR)

(72) Inventors: Vincent MARQUIS, DRUMMONDVILLE (CA); Abel AIT SAID, TROIS RIVIÈRES (CA); Emmanuel DIAYELE, TROIS RIVIÈRES (CA)

(21) Appl. No.: 19/084,056

(22) Filed: Mar. 19, 2025

(30) Foreign Application Priority Data
Mar. 20, 2024 (FR) 2402760

(51) Int. Cl. F24F 12/00; F24F 7/00; F24F 7/06

(52) U.S. Cl. CPC F24F 12/006; F24F 7/06; F24F 2007/001

(57) ABSTRACT

A controlled mechanical double-flow ventilation box including at least one air intake vent connected to an intake volume and at least one air discharge vent connected to a discharge volume, the intake volume and the discharge volume are separated by a partition wall, the ventilation box comprising a heat exchanger, the intake vent being positioned opposite an inlet face of the air in the heat exchanger, characterized in that the partition wall comprises a first part which has a curved shape partly around the intake vent and partly around the discharge vent.

### CROSS REFERENCE TO RELATED APPLICATIONS

This application claims priority under 35 U.S.C. § 119 to the following French Patent Application No. 2402760, filed on Mar. 20, 2024, the entire contents of which are incorporated herein by reference thereto.

### TECHNICAL FIELD

The present disclosure concerns the field of controlled dual-flow mechanical ventilation installations and more particularly to a controlled dual-flow mechanical ventilation box for a building, and to a controlled mechanical ventilation system equipped with this ventilation box.

### BACKGROUND

A controlled dual-flow mechanical ventilation system for a building is intended to allow an air renewal in the building while ensuring a heat exchange between a flow of blown air and a flow of extracted air. Subsequently, the air blown into the building may also be referred to as fresh air, and the air extracted from the building may be referred to as stale air.

The controlled dual-flow mechanical ventilation system conventionally includes:
a network of blowing ducts intended for blowing fresh air into the building and more particularly into rooms used primarily;
a network of extracting ducts intended for extracting stale air from the building and more particularly from technical rooms or wet rooms; and
a ventilation box comprising on the one hand a heat exchanger allowing the extracted air to transfer thermal calories to the blown air, and on the other hand at least two fans to circulate the extracted air and the blown air in the duct networks.

A ventilation box known from the state of the art is of substantially parallelepiped shape and includes at least one fresh air intake vent in the ventilation box, one fresh air intake vent in the building, one stale air intake vent in the ventilation box and one stale air discharge vent from the ventilation box. A fresh air circuit connects, in a sealed manner, the fresh air intake vent to the fresh air supply vent, and a stale air circuit connects, in a sealed manner, the stale air intake vent and the stale air discharge vent, so that the fresh air and stale air do not mix. The fresh air circuit and the stale air circuit each pass through the heat exchanger.

The maximum flow rate of supplied air and the maximum flow rate of air extracted from the building are generally close to each other, and are determined in particular according to the size of the building.

The maximum flow rate that can be generated by the ventilation box is generally directly proportional to its total volume. Indeed, the larger the volume of the ventilation box, the lower the pressure losses within the ventilation box, and therefore the greater the flow rate that can be generated, and vice versa. A large volume of the ventilation box allows enough space for the fans to operate at their full potential.

Moreover, for a given maximum flow rate, an improvement in the energy efficiency of the ventilation box leads to an increase in pressure losses and therefore an increase in volume.

The term «Energy efficiency» means the amount of thermal calories exchanged between stale air and fresh air compared to the flow rate of stale air and fresh air circulating in the ventilation box.

The construction industry seeks to optimize the space of the building while improving the energy performance. The construction industry is therefore looking for ventilation boxes that have, for a given maximum flow rate, both a low volume and high energy efficiency.

### BRIEF SUMMARY

One embodiment concerns a dual-flow controlled mechanical ventilation box comprising at least one air intake vent connected to an intake volume and at least one air discharge vent connected to a discharge volume, the intake volume and the discharge volume are separated by a partition wall, the ventilation box comprising a heat exchanger, the intake vent being positioned opposite an air inlet face in the heat exchanger, characterized in that the partition wall comprises a first part which has a curved shape partly around the intake vent and partly around the discharge vent.

The dual-flow controlled ventilation box is configured to be connected to a controlled mechanical ventilation system of a building. The ventilation box is therefore configured to be fixed to a fresh air circuit and a stale air circuit of the building by means of at least one air intake vent and at least one air discharge vent.

The intake or discharge vent is an opening made in a wall of the ventilation box.

The term «air intake vent» means a vent that is configured to be connected to the fresh air circuit or the stale air circuit and through which air is intended to enter the ventilation box, hereinafter called the incoming air flow. In other words, through the intake vent, air passes from the air circuit into the ventilation box.

The ventilation box includes at least one fresh air intake vent and at least one stale air intake vent.

The term «air discharge vent» means a vent that is configured to be connected to the fresh air circuit or to the stale air circuit and through which the air is intended to exit the ventilation box, hereinafter called the discharge air flow. In other words, through the discharge vent, the air passes from the ventilation box into the air circuit.

The ventilation box includes at least one fresh air discharge vent, also called fresh air insufflation, and at least one stale air discharge vent.

The ventilation box also comprises a heat exchanger configured to allow the stale air to transfer its thermal calories to the fresh air.

The heat exchanger comprises in particular an inlet face, that is to say a face configured to allow the air to enter the heat exchanger.

The heat exchanger also comprises an outlet face, that is to say a face configured to allow the air to exit the heat exchanger.

According to a characteristic of the present disclosure, the inlet face is substantially planar.

According to a characteristic of the present disclosure, the outlet face is substantially planar.

The heat exchanger comprises a fresh air inlet face and a stale air inlet face, a fresh air outlet face and a stale air outlet face.

The intake vent is positioned opposite, that is to say opposite, the inlet face of the heat exchanger so as to direct the incoming air flow onto this inlet face. The intake vent extends at a distance from the inlet face.

The intake volume is defined by the volume of air between the intake vent and the inlet face of the heat exchanger. Thus, one wall of the intake volume is the wall on which the intake vent extends, another wall of the intake volume is the inlet face of the heat exchanger.

The discharge volume is defined by the volume of air between the outlet face of the heat exchanger and the discharge vent. Thus, one wall of the discharge volume is the wall on which the discharge vent extends, another wall of the discharge volume is the outlet face of the heat exchanger.

The discharge and intake volumes are separated by the partition wall. In other words, the partition wall is a wall of the discharge volume and the intake volume. More particularly, one face of the partition wall is in contact with the intake volume, and one face, opposite the face of the partition wall in contact with the intake volume, is in contact with the discharge volume.

The partition wall comprises a first part which has a curved shape, that is to say the surface of the partition wall is not planar. The first part of the partition wall comprises curved lines.

More particularly, the first part is curved on the one hand partly around the intake vent and on the other hand partly around the discharge vent. In other words, the first part partly bypasses the intake vent and the discharge vent.

Thus, the partition wall is configured to direct the flow of incoming air, respectively discharged, respectively towards the intake vent, respectively the discharge vent. By its specific shape, the partition wall makes it possible to reduce pressure losses of the ventilation box and thus increase the flow rates of incoming and discharged air.

The present disclosure makes it possible to obtain a ventilation box with a high air flow rate while minimizing a total volume of the ventilation box compared to the state of the art.

The subject of the present disclosure may also have one or more of the following characteristics taken alone or in combination.

In certain embodiments, a first end of the first part is oriented towards the discharge vent and a second end of the first part is oriented towards the intake vent.

In other words, the first end of the first part is closer to the discharge vent than to the intake vent, while the second end of the first part is closer to the intake vent than to the discharge vent.

Thus, by the same wall, the intake volume and the discharge volume are optimized. The total volume of the ventilation box is therefore optimized.

In some embodiments, the first part has an S shape.

The first part undulates, that is to say forms a sinuous line, between the intake vent and the discharge vent.

In some embodiments, the air discharge vent has a circular shape, the first part going around the air discharge vent at a distance from the center of the discharge vent of at least 1.2 times, preferably at least 1.5 times, for example 1.52 times a diameter of the air discharge vent.

In some embodiments, the air intake vent has a circular shape, the first part going around the air intake vent at a distance from the center of the intake vent of at least 1.2 times, preferably 1.5 times, for example 1.52 times a diameter of the air intake vent.

Thus, the partition wall allows the best compromise between the pressure losses during the discharge of air and the entry of air into the heat exchanger.

In some embodiments, the partition wall comprises a second part extending opposite the inlet face of the heat exchanger.

The second part of the partition wall is configured to force the incoming air to be diffused over the entire inlet face of the heat exchanger. Thus, a heat exchange within the heat exchanger is homogenized. An energy efficiency of the heat exchanger is therefore optimized. In other words, the second part makes it possible to maximize a capacity of the heat exchanger to transfer the thermal calories from the stale air to the fresh air.

In some embodiments, an edge of the second part of the partition wall is in contact with the inlet face of the heat exchanger.

In some embodiments, the second part of the partition wall is substantially planar.

In some embodiments, the second part of the partition wall forms an angle of at least 10°, preferably at least 14°, for example at least 14.15° with the inlet face of the heat exchanger.

Thus, the second part of the partition wall allows a uniform or quasi-uniform diffusion of the air entering the heat exchanger while providing sufficient space for the air outlet from the ventilation box.

In some embodiments, the intake volume comprises an intake wall provided with a first side in contact with a partition wall and a second side in contact with the inlet face of the heat exchanger.

The intake wall makes it possible to reduce a size of the intake volume so that the incoming flow is more easily directed towards the inlet face of the heat exchanger.

In some embodiments, the intake wall is substantially planar.

In some embodiments, the intake wall comprises a third side in contact with the wall on which the intake vent extends.

In some embodiments, the intake volume is delimited by walls forming an outer wall of the ventilation box.

In some embodiments, the discharge volume comprises a fan.

The fan is therefore positioned in the discharge volume.

In some embodiments, at least one wall of the discharge volume surrounds the fan at a distance from the center of the fan comprised between 1 and 1.5 times, preferably between 1.1 and 1.2 times, for example 1.13 times a diameter of the fan.

It is customary to leave a space around the fan of 1.6 times the diameter of the fan in order to optimize its operation. However, with the partition wall according to the present disclosure, a distance of 1.13 times the diameter of the fan is sufficient. This makes it possible to reduce the total volume of the ventilation box.

Another aspect of the present disclosure concerns a controlled mechanical ventilation system comprising a ventilation box according to the present disclosure.

### BRIEF DESCRIPTION OF THE DRAWINGS

The present disclosure will be better understood, thanks to the description below, which relates to an embodiment according to the present disclosure, given as a non-limiting example and explained with reference to the appended schematic drawings, in which:

FIG. 1 is a three-dimensional representation of a ventilation box according to the present disclosure,

FIG. 2 is a three-dimensional representation of an internal part of the ventilation box according to the present disclosure,

FIG. 3 is a view of the ventilation box according to the present disclosure,

FIG. 4 is a diagram of FIG. 3,

FIG. 5 is a view of a discharge volume of the ventilation box according to the present disclosure,

FIG. 6 is a view of an intake volume of the ventilation box according to the present disclosure, and

FIG. 7 is a diagram of FIG. 6.

### DETAILED DESCRIPTION

Only the elements necessary for understanding the present disclosure have been shown. To facilitate reading of the drawings, the same elements bear the same references from one figure to another.

The present disclosure relates to a dual-flow controlled mechanical ventilation box 1, as illustrated in FIG. 1, configured to be connected to a controlled mechanical ventilation system of a building. The ventilation box 1 is therefore configured to be fixed to a fresh air circuit and a stale air circuit of the building by means of at least one air intake vent 2 and at least one air discharge vent 3.

The intake 2 or discharge vent 3 is an opening made in a wall of the ventilation box.

The term air intake vent 2 means a vent that is configured to be connected to the fresh air circuit or to the stale air circuit and through which the air is intended to enter the ventilation box 1, hereinafter called the incoming air flow. In other words, through the intake vent 2, the air passes from the air circuit into the ventilation box 1.

The ventilation box 1 includes at least one fresh air intake vent and at least one stale air intake vent.

Preferably, the intake vent 2 has a circular shape.

The air intake vent 2 is connected to an intake volume 21.

The term air discharge vent 3, means a vent that is configured to be connected to the fresh air circuit or to the stale air circuit and through which the air is intended to exit the ventilation box 1, hereinafter called the discharged air flow. In other words, through the discharge vent 3, the air passes from the ventilation box 1 into the air circuit.

The ventilation box 1 includes at least one fresh air discharge vent and at least one stale air discharge vent.

Preferably, the discharge vent 3 has a circular shape.

The air discharge vent 3 is connected to a discharge volume 31.

The ventilation box 1 also comprises a heat exchanger 4 configured to allow the stale air to give up its thermal calories to the fresh air.

The heat exchanger 4 comprises in particular an inlet face 41, that is to say a face configured to allow the air to enter the heat exchanger.

The heat exchanger 4 also comprises an outlet face 42, that is to say a face configured to allow the air to exit the heat exchanger 4.

According to a characteristic of the present disclosure, the inlet face 41 is substantially planar.

According to a characteristic of the present disclosure, the outlet face 42 is substantially planar.

The heat exchanger 4 comprises a fresh air inlet face and a stale air inlet face, a fresh air outlet face and a stale air outlet face.

According to a characteristic, the heat exchanger 4 has the shape of a hexagonal prism.

In FIG. 1, the heat exchanger 4 is not shown.

Preferably, the heat exchanger 4 is a counter-current plate exchanger.

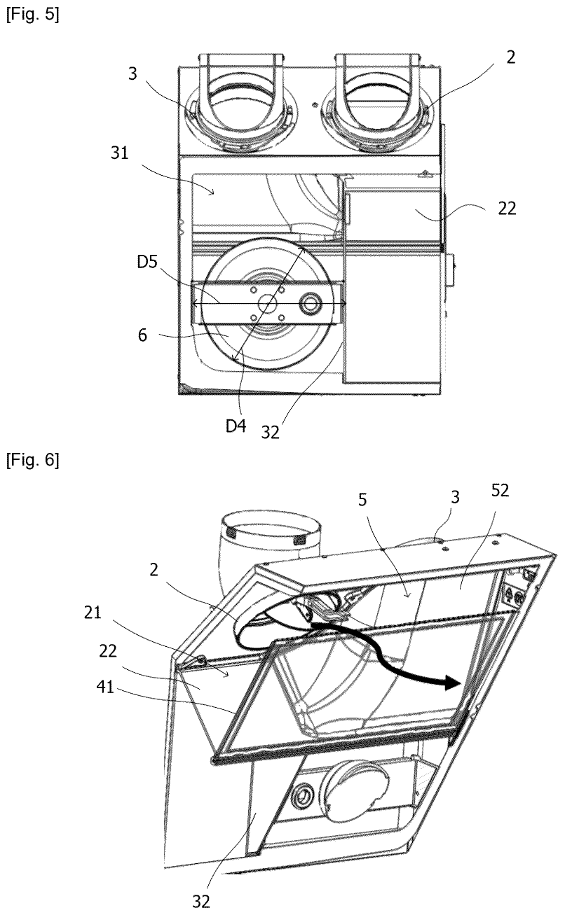

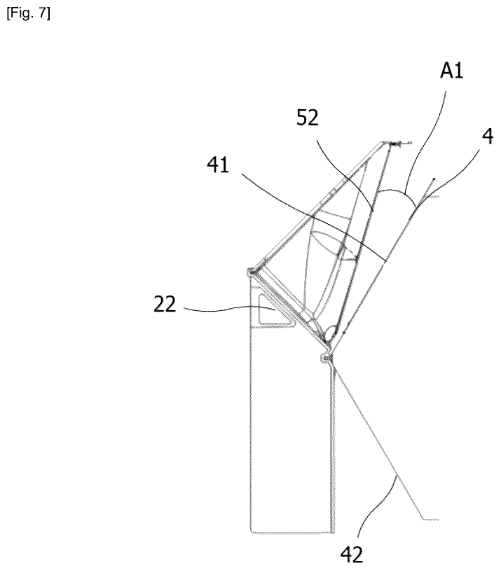

The intake vent 2 is positioned opposite, that is to say opposite, the inlet face 41 of the heat exchanger 4 so as to direct the incoming air flow onto this inlet face 41, as illustrated in FIG. 6. The intake vent 2 extends at a distance from the inlet face 41. The intake volume 21 is defined by the volume of air between the intake vent 2 and the inlet face 41 of the heat exchanger 4. Thus, a wall of the intake volume 21 is the wall on which the intake vent 2 extends, another wall of the intake volume 21 is the inlet face 41 of the heat exchanger 4.

The intake volume 21 is also delimited by a partition wall 5, an intake wall 22 provided with a first side in contact with the partition wall 5 and a second side in contact with the inlet face 41 of the heat exchanger 4. The first side and the second side of the intake wall 22 are substantially perpendicular to each other.

In some embodiments, the intake wall 22 is substantially planar.

In some embodiments, the intake wall 22 comprises a third side in contact with the wall on which the intake vent extends. The third side extends substantially parallel to the second side, and substantially perpendicular to the first side.

In some embodiments, the intake volume 21 is delimited by walls forming an outer wall of the ventilation box 1.

The intake wall 22 makes it possible to reduce a size of the intake volume 21 so that the incoming flow is more easily directed towards the inlet face 41 of the heat exchanger 4.

The discharge volume 31 is defined by the volume of air between the outlet face 42 of the heat exchanger 4 and the discharge vent 3. Thus, one wall of the discharge volume 31 is the wall on which the discharge vent 3 extends, another wall of the discharge volume 31 is the outlet face 42 of the heat exchanger 4. The discharge volume 31 is also delimited by the partition wall 5, a reduction wall 32, and walls forming an outer wall of the ventilation box 1.

The reduction wall 32 limits a size of the discharge volume 31. The reduction wall 32 extends between an outer wall of the ventilation box, the partition wall 5, and the outlet face 42 of the heat exchanger 4. The reduction wall 32 is substantially planar.

In some embodiments, the discharge volume 31 comprises a fan 6, for example illustrated in FIG. 5.

In some embodiments, at least one wall of the discharge volume 31 surrounds the fan 6 at a distance D5 from the center of the fan 6 comprised between 1 and 1.5 times, preferably between 1.1 and 1.2 times, for example 1.13 times a diameter D4 of the fan 6. In other words, for example with a diameter of the fan 6 of 7.70″, a wall of the discharge volume 31 which surrounds the fan 6 is at least at a distance D5 from the center of the fan of 8.77″.

It is customary to leave a space around the fan of 1.6 times the diameter of the fan in order to optimize its operation. However, with the partition wall 5 according to the present disclosure, a distance of 1.13 times the diameter of the fan 6 is sufficient. This makes it possible to reduce the total volume of the ventilation box 1.

The discharge 31 and the intake volume 21 are separated by the partition wall 5. In other words, the partition wall 5 is a wall of the discharge volume 31 and the intake volume 21.

For example, the ventilation box comprises at least two partition walls, each separating a discharge volume 31 from an intake volume 21.

For example, a first partition wall separates the discharge volume 31 connected to the fresh air discharge vent and the intake volume connected to the stale air intake vent, a second partition wall separates the discharge volume connected to the stale air discharge vent and the intake volume connected to the fresh air intake vent.

More particularly, a face 5a of the partition wall 5 is in contact with the intake volume 21, and a face 5b, opposite the face 5a of the partition wall 5 in contact with the intake volume 21, is in contact with the discharge volume 31.

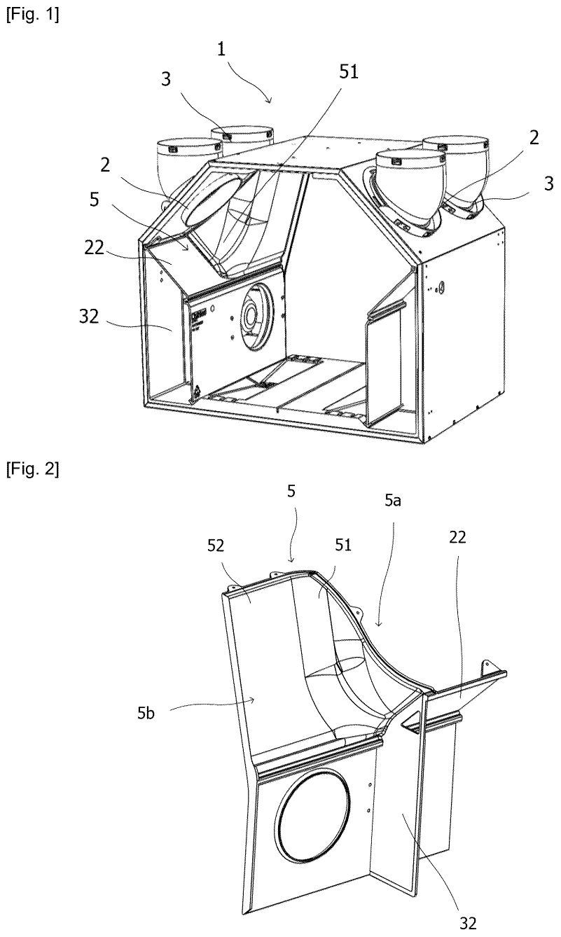

The partition wall 5, illustrated in FIG. 2, comprises a first part 51 which has a curved shape, that is to say the surface of the partition wall 5 is not planar. The first part 51 of the partition wall 5 comprises curved lines.

More particularly, the first part 51 has a curved shape partly around the intake vent 2 and partly around the discharge vent 3. In other words, the first part 51 partly bypasses the intake vent 2 and the discharge vent 3.

In some embodiments, a first end 511 of the first part 51 is oriented toward the discharge vent 3 and a second end 512 of the first part 51 is oriented toward the intake vent 2.

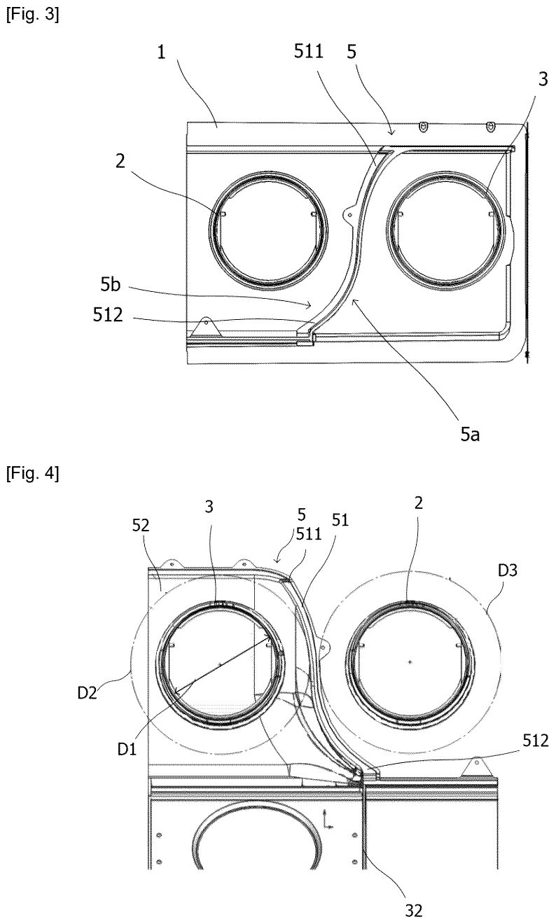

In other words, the first end 511 of the first part 51 is closer to the discharge vent 3 than to the intake vent 2, while the second end 512 of the first part 51 is closer to the intake vent 2 than to the discharge vent 3 as illustrated in FIGS. 3 and 4.

In some embodiments, the first part 51 has an S shape.

The first part 51 undulates, that is to say forms a sinuous line, between the intake vent 2 and the discharge vent 3.

In some embodiments, for example illustrated in FIG. 4, the first part 51 goes around the air discharge vent 3 at a distance D2 from the center of the discharge vent 3 of at least 1.2 times, preferably at least 1.5 times, for example 1.52 times a diameter of the air discharge vent 3. In other words, for example with a diameter D1 of the discharge vent of 4.9″, the first part 51 is at least at a distance D2 from the center of the discharge vent 3 of 7.46″.

In some embodiments, for example illustrated in FIG. 4, the first part 51 goes around the air intake vent 2 at a distance from the center of the intake vent 2 of at least 1.2 times, preferably 1.5 times, for example 1.52 times a diameter of the air intake vent 2. In other words, for example with a diameter of the intake vent 2 of 4.9″, the first part 51 is at least at a distance D3 from the center of the intake vent 2 of 7.59″.

Thus, the partition wall 5 allows the best compromise between pressure losses during the discharge of air and the entry of air into the heat exchanger 4.

In certain embodiments, the partition wall 5 comprises a second part 52 extending opposite the inlet face 41 of the heat exchanger 4.

The second part 52 of the partition wall 5 is configured to force the incoming air to diffuse over the entire inlet face 41 of the heat exchanger 4, as illustrated in FIG. 6. Thus, a heat exchange within the heat exchanger 4 is homogenized. An energy efficiency of the heat exchanger 4 is therefore optimized. In other words, the second part 52 makes it possible to maximize a capacity of the heat exchanger 4 to transfer the thermal calories from the stale air to the fresh air.

In some embodiments, an edge of the second part 52 of the partition wall 5 is in contact with the inlet face 41 of the heat exchanger 4.

In some embodiments, the second part 52 of the partition wall 5 is substantially planar.

In some embodiments, for example illustrated in FIG. 7, the second part 52 of the partition wall 5 forms an angle A1 of at least 10°, preferably at least 14°, for example at least 14.15° with the inlet face 41 of the heat exchanger 4.

Thus, the second part 52 of the partition wall 5 allows uniform or quasi-uniform diffusion of the air entering the heat exchanger 4 while providing sufficient space for the air outlet of the ventilation box 1.

The partition wall 5 according to the present disclosure is configured to direct the flow of incoming air, respectively discharged, respectively towards the intake vent 2, respectively the discharge vent 3. By its specific shape, the partition wall 5 makes it possible to reduce the pressure losses of the ventilation box and thus increase the flow rates of incoming and discharged air. Thus, by the same wall, the intake volume and the discharge volume are optimized. The total volume of the ventilation box 1 is therefore optimized.

The present disclosure makes it possible to obtain a ventilation box 1 with a high air flow rate while minimizing a total volume of the ventilation box 1 compared to the state of the art.

Although the present disclosure has been described with reference to specific embodiments, it is obvious that modifications and changes can be made to these examples without departing from the general scope of the present disclosure as defined by the claims. In particular, individual characteristics of the different illustrated/mentioned embodiments can be combined in additional embodiments. Consequently, the description and the drawings should be considered in an illustrative rather than restrictive sense.

It is also obvious that all the characteristics described with reference to a method are transposable, alone or in combination, to a device, and conversely, all the characteristics described with reference to a device are transposable, alone or in combination, to a method.

1. A controlled mechanical double-flow ventilation box comprising at least one air intake vent connected to an intake volume and at least one air discharge vent connected to a discharge volume, the intake volume and the discharge volume are separated by a partition wall, the ventilation box comprising a heat exchanger, the intake vent being positioned opposite an inlet face of the heat exchanger, characterized in that the partition wall comprises a first part which has a curved shape partly around the intake vent and partly around the discharge vent.

2. The ventilation box according to claim 1, wherein a first end of the first part is oriented towards the discharge vent and a second end of the first part is oriented towards the intake vent.

3. The ventilation box according to claim 1, wherein the first part has an S shape.

4. The ventilation box according to claim 1, wherein the air discharge vent has a circular shape, the first part going around the air discharge vent at a distance from a center of the discharge vent of at least 1.2 times a diameter of the air discharge vent.

5. The ventilation box according to claim 1, wherein the air intake vent has a circular shape, the first part going around the air intake vent at a distance from a center of the intake vent of at least 1.2 times a diameter of the air intake vent.

6. The ventilation box according to claim 1, wherein the partition wall comprises a second part extending opposite the inlet face of the heat exchanger.

7. The ventilation box according to claim 6, wherein the second part of the partition wall forms an angle of at least 10° with the inlet face of the heat exchanger.

8. The ventilation box according to claim 1, wherein the intake volume comprises an intake wall provided with a first side in contact with the partition wall and a second side in contact with the inlet face of the heat exchanger.

9. The ventilation box according to claim 1, wherein the discharge volume comprises a fan.

10. A controlled mechanical ventilation system comprising a ventilation box according to claim 1.

11. The ventilation box according to claim 4, wherein the distance from the center of the discharge vent is 1.5 times the diameter of the air discharge vent.

12. The ventilation box according to claim 4, wherein the distance from the center of the discharge vent is 1.52 times the diameter of the air discharge vent.

13. The ventilation box according to claim 5, wherein the distance from the center of the discharge vent is 1.5 times the diameter of the air discharge vent.

14. The ventilation box according to claim 5, wherein the distance from the center of the discharge vent is 1.52 times the diameter of the air discharge vent.

15. The ventilation box according to claim 2, wherein the first part has an S shape.

16. The ventilation box according to claim 15, wherein the air discharge vent has a circular shape, the first part going around the air discharge vent at a distance from a center of the discharge vent of at least 1.2 times a diameter of the air intake vent.

17. The ventilation box according to claim 16, wherein the air intake vent has a circular shape, the first part going around the air intake vent at a distance from the center of the intake vent of at least 1.2 times a diameter of the air intake vent.

18. The ventilation box according to claim 17, wherein the partition wall comprises a second part extending opposite the inlet face of the heat exchanger.

19. The ventilation box according to claim 18, wherein the second part of the partition wall forms an angle of at least 10° with the inlet face of the heat exchanger.

20. The ventilation box according to claim 19, wherein the intake volume comprises an intake wall provided with a first side in contact with the partition wall and a second side in contact with the inlet face of the heat exchanger.
